(19) United States
(12) Patent Application Publication
(10) Pub. No.: US 2025/0206041 A1
(43) Pub. Date: Jun. 26, 2025

(54) PHOTOIRRADIATION UNIT, PRINTER, AND PRINTING SYSTEM

(71) Applicant: SCREEN Holdings Co., Ltd., Kyoto (JP)

(72) Inventor: Yoshihiro MASUYA, Kyoto-shi, Kyoto (JP)

(21) Appl. No.: 18/848,987

(22) PCT Filed: Dec. 22, 2022
(86) PCT No.: PCT/JP2022/047343

§ 371 Date: Sep. 20, 2024

(30) Foreign Application Priority Data
Mar. 22, 2022 (JP) 2022-045270

(51) Int. Cl. B41J 11/00

(52) U.S. Cl. CPC B41J 11/00218

(57) ABSTRACT

A photoirradiation unit includes a case, a light source, a light converging lens, and a light transmissible member. The case has a lower surface having an opening. The light source and the light converging lens are arranged in the case. The light transmissible member is arranged in the opening of the case. The light converging lens causes the light emitted from the light source to converge. The light transmissible member permeates the light that has converged by the light converging lens. The light transmissible member has a flat lower surface. Accordingly, it is possible to reduce the occurrence of disturbances in the airflow produced by the light converging lens between the photoirradiation unit and the print medium.

### TECHNICAL FIELD

The present invention relates to a photoirradiation unit, a printer, and a printing system.

### BACKGROUND ART

A printing system is conventionally known in which printing is performed on a surface of a band-like print medium by ejecting ink from a plurality of ejection heads onto the print medium while transporting the print medium. There are cases where this type of printing system uses photo-curing ink that is cured with light such as ultraviolet rays. In that case, after the ejection of the ink from the ejection heads onto the print medium, the ink is irradiated with light. In this way, the ink is cured and fixed to the print medium.

Conventional printing systems that use photo-curing ink are disclosed in, for example, Patent Literatures (PTLs) 1 and 2.

### CITATION LIST

### Patent Literature

PTL 1: Japanese Patent Application Laid-Open No. 2012-020481
PTL 2: Japanese Patent Application Laid-Open No. 2021-049655

### SUMMARY OF INVENTION

### Technical Problem

Such printing systems require high-speed print processing. To increase the speed of print processing, high-speed transport of a print medium becomes necessary. In that case, in order to cure ink, it is also necessary to increase the amount of light applied per unit area of a print medium. For example, it is conceivable to cause the light emitted from a light source to converge by a light converging lens and to irradiate the upper surface of a print medium with the light.

However, along with the movement of the print medium, an airflow that is flowing downward in the transport direction is produced in the vicinity of the upper surface of the print medium. Besides, this airflow contains a fine mist of ink produced during the ejection of the ink from the ejection heads.

In the case where the light converging lens is arranged at a position facing the upper surface of the print medium, the convex surface of the light converging lens disturbs the aforementioned airflow. Accordingly, the mist of ink contained in the airflow adheres to the lower surfaces of the ejection heads or other places. If the adhering mist is accumulated and becomes a relatively large droplet, the droplet may drop onto the upper surface of the print medium.

The present invention has been made in light of such circumstances, and it is an object of the present invention to provide a technique for using a photoirradiation unit that includes a light converging lens and also reducing the occurrence of disturbances in an airflow produced by the light converging lens between the photoirradiation unit and a print medium.

### Solution to Problem

A first aspect of the present application is a photoirradiation unit for irradiating photo-curing ink supplied to a print medium with light. The photoirradiation unit includes a case having a lower surface having an opening, a light source arranged in the case, a light converging lens that is arranged in the case and that causes light emitted from the light source to converge, and a light transmissible member that is arranged in the opening of the case and that permeates light that has converged by the light converging lens. The light transmissible member has a flat lower surface.

A second aspect of the present application is the photoirradiation unit according to the first aspect, in which light that has been emitted from the light source and permeated the light converging lens and the light transmissible member forms a spot of a predetermined area on a surface of the print medium, and the light source and the light converging lens are located in height positions that are higher than height positions in which the light source and the light converging lens are located when the spot of the predetermined area is formed on the print medium in the absence of said light transmissible member.

A third aspect of the present application is the photoirradiation unit according to the first or second aspect, in which the lower surface of the light transmissible member and the lower surface of the case are located in the same plane or in approximately the same plane.

A fourth aspect of the present application is the photoirradiation unit according to any one of the first to third aspects, in which the light converging lens is a rod lens that extends in parallel with the lower surface of the case.

A fifth aspect of the present application is a printing system that includes a transport mechanism that transports a print medium along a predetermined transport path, an ejection head that ejects photo-curing ink from a plurality of ink ejection outlets to the print medium that is transported by the transport mechanism, a first base that supports the ejection head, the photoirradiation unit according to any one of the first to forth aspects, and a second base that supports the photoirradiation unit. The photoirradiation unit irradiates the print medium with light on a downstream side of the ejection head in the transport path. The lower surface of the light transmissible member and a lower surface of the second base are located in the same plane or in approximately the same plane.

A sixth aspect of the present application is the printing system according to the fifth aspect, in which a lower surface of the ejection head, a lower surface of the first base, the lower surface of the light transmissible member, and the lower surface of the second base are located in the same plane or in approximately the same plane.

A seventh aspect of the present application is a printer that includes a transport mechanism that transports a print medium along a predetermined transport path, an ejection head that ejects photo-curing ink from a plurality of ink ejection outlets to the print medium that is transported by the transport mechanism, a first base that supports the ejection head, and a second base capable of supporting a photoirradiation unit that irradiates the ink supplied to the print medium with light via a light converging lens. The second base includes a base plate having an opening, and a light transmissible member arranged in the opening. The light transmissible member has a flat lower surface.

An eighth aspect of the present application is the printer according to the seventh aspect, in which when the photoirradiation unit is supported by the second base, a lower surface of the ejection head, a lower surface of the first base, the lower surface of the light transmissible member, and a lower surface of the second base are located in the same plane or in approximately the same plane.

A ninth aspect of the present application is the printer according to the seventh or eighth aspect, in which the second base has rectifier surfaces that are located on upstream and downstream sides of the opening in the transport direction of the print medium and that extends in a direction toward the lower surface of the light transmissible member.

A tenth aspect of the present application is a photoirradiation unit for irradiating photo-curing ink supplied to a print medium with light. The photoirradiation unit includes a light source that emits light, a light converging lens that causes the light emitted from the light source to converge, and rectifier surfaces that are located on upstream and downstream sides of the light converging lens in a transport direction of the print medium and that extends in a direction toward a vicinity of a lower end portion of the light converging lens.

An eleventh aspect of the present application is the photoirradiation unit according to the tenth aspect, in which the rectifier surfaces include a first rectifier surface that is located upstream of the light converging lens in the transport direction of the print medium and that is inclined to have gradually increased height in the direction toward the vicinity of the lower end portion of the light converging lens, and a second rectifier surface that is located downstream of the light converging lens in the transport direction of the print medium and that is inclined to have gradually increased height in the direction toward the vicinity of the lower end portion of the light converging lens.

A twelfth aspect of the present application is a printing system that includes a transport mechanism that transports a print medium in a predetermined transport path, an ejection head that ejects photo-curing ink from a plurality of ink ejection outlets to the print medium that is transported by the transport mechanism, a first base that supports the ejection head, the photoirradiation unit according to the tenth or the eleventh aspect, and a second base that supports the photoirradiation unit. The photoirradiation unit irradiates the print medium with light at a position located downstream of the ejection head in the transport path. The rectifier surfaces and a lower surface of the second base guide an airflow that is flowing above the print medium.

A thirteenth aspect of the present application is the printing system according to the twelfth aspect, in which the rectifier surfaces, a lower surface of the ejection head, a lower surface of the first base, and the lower surface of the second base guide the airflow that is flowing above the print medium.

A fourteenth aspect of the present application is a printer that includes a transport mechanism that transports a print medium along a predetermined transport path, an ejection head that ejects photo-curing ink from a plurality of ink ejection outlets to the print medium that is transported by the transport mechanism, a first base that supports the ejection head, and a second base capable of supporting a photoirradiation unit that irradiates the ink supplied to the print medium with light via a light converging lens. The second base has rectifier surfaces that are located on upstream and downstream sides of the light converging lens in a transport direction of the print medium and extends in a direction toward a vicinity of a lower end portion of the light converging lens, while the second base supports the photoirradiation unit.

### Advantageous Effects of Invention

According to the first to sixth aspects of the present application, the light transmissible member having a flat lower surface is arranged on the lower surface of the case of the photoirradiation unit. This reduces the occurrence of disturbances in the airflow produced by the light converging lens between the photoirradiation unit and the print medium.

In particular, according to the third to sixth aspects of the present application, it is possible to further reduce the occurrence of disturbances in the airflow between the photoirradiation unit and the print medium.

According to the seventh to ninth aspects of the present application, the light transmissible member having a flat lower surface is arranged in the opening of the second base that supports the photoirradiation unit. This reduces the occurrence of disturbances in the airflow produced by the light converging lens between the photoirradiation unit and the print medium.

In particular, according to the eighth and ninth aspects of the present application, it is possible to further reduce the occurrence of disturbances in the airflow between the photoirradiation unit and the print medium.

According to the tenth to thirteenth aspects of the present application, the rectifier surfaces are provided on the upstream and downstream sides of the light converging lens. This reduces the occurrence of disturbances in the airflow produced by the light converging lens between the photoirradiation unit and the print medium.

In particular, according to the twelfth and thirteenth aspects of the present application, it is possible to further reduce the occurrence of disturbances in the airflow between the photoirradiation unit and the print medium.

According to the fourteenth aspect of the present application, the rectifier surfaces are provided on the upstream and downstream sides of the light converging lens. This reduces the occurrence of disturbances in the airflow produced by the light converging lens between the photoirradiation unit and the print medium.

### BRIEF DESCRIPTION OF DRAWINGS

FIG. 1 illustrates a configuration of a printing system.

FIG. 2 is a control block diagram of the printing system.

FIG. 3 illustrates configurations of one photoirradiation unit and one second base according to a first embodiment.

FIG. 4 shows the arrangement of a light source and a light converging lens in the case (a) where there is no light transmissible member (Comparative Example) and in the case (b) where there is a light transmissible member (Example).

FIG. 5 illustrates configurations of one photoirradiation unit and one second base according to a second embodiment.

FIG. 6 illustrates configurations of one photoirradiation unit and one second base according to a third embodiment.

FIG. 7 illustrates configurations of one photoirradiation unit and one second base according to a fourth embodiment.

FIG. 8 illustrates configurations of one photoirradiation unit and one second base according to a fifth embodiment.

### DESCRIPTION OF EMBODIMENTS

Hereinafter, embodiments of the present invention will be described with reference to the drawings.

### 1. Configuration of Printing System

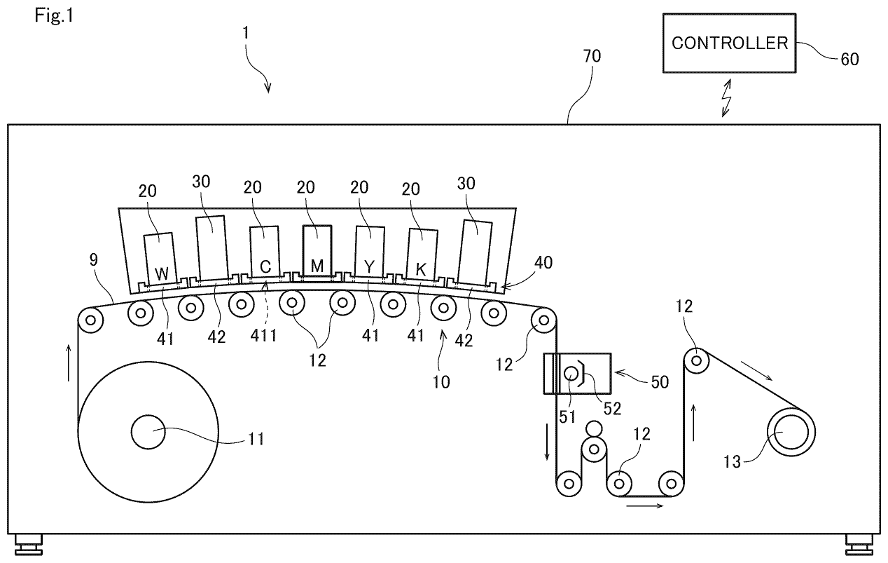

FIG. 1 illustrates a configuration of a printing system 1 according to one embodiment of the present invention. This printing system 1 is an apparatus that prints an image on a surface of a long band-like print medium 9 by ejecting ink droplets from a plurality of ejection heads 20 toward the print medium 9 while transporting the print medium 9. The print medium 9 may be printing paper or may be a resin film.

As shown in FIG. 1, the printing system 1 includes a transport mechanism 10, five ejection heads 20, two photoirradiation units 30, a base unit 40, a fixing unit 50, and a controller 60. The constituent elements other than the controller 60 are placed inside a box-like housing 70. In the printing system 1, an apparatus configured by the transport mechanism 10, the ejection heads 20, and the base unit 40 is one example of the “printer” according to the present invention.

The transport mechanism 10 is a mechanism for transporting the print medium 9 in a transport direction that is along the longitudinal direction of the print medium 9. The transport mechanism 10 according to the present embodiment includes an unwinder 11, a plurality of transport rollers 12, and a rewinder 13. The print medium 9 is unwound from the unwinder 11 and transported along a transport path configured by the transport rollers 12. Each transport roller 12 guides the print medium 9 to the downstream side in the transport path by rotating about an axis extending in a direction perpendicular to the transport direction and horizontal. The print medium 9 runs on the transport rollers 12 under tension. This reduces the occurrence of slack or creases in the print medium 9 during transport. The transported print medium 9 is collected by the rewinder 13.

The five ejection heads 20 are units that eject ink droplets onto the print medium 9 that is transported by the transport mechanism 10. The five ejection heads 20 are aligned at intervals in the transport direction of the print medium 9. The print medium 9 with its printing surface facing upward is transported under the five ejection heads 20. Each ejection head 20 has a lower surface having a large number of ink ejection outlets. The five ejection heads 20 eject ink of white (W), cyan (C), magenta (M), yellow (Y), and black (K) colors, respectively, from the ink ejection outlets toward the upper surface of the print medium 9. Accordingly, a multicolor image is formed on the upper surface of the print medium 9.

The ink ejected from the ejection heads 20 is photo-curing ink. The photo-curing ink is ink that is cured by irradiation with light such as ultraviolet rays. In the printing system 1 according to the present embodiment, after the ink is ejected from the ejection heads 20 to the print medium 9, the photoirradiation units 30 and the fixing unit 50 irradiate the ink on the print medium 9 with light so as to cure the ink.

The two photoirradiation units 30 are units that semi-cure the ink by irradiating the ink ejected from the ejection heads 20 onto the upper surface of the print medium 9 with light. In the present embodiment, the photoirradiation units 30 are arranged on the downstream side of the ejection head 20 that ejects white (W) color ink and on the downstream side of the ejection head 20 that ejects black (K) color ink.

Each photoirradiation unit 30 irradiates the upper surface of the print medium 9 transported by the transport mechanism 10 with light. Accordingly, the ink adhering to the upper surface of the print medium 9 is irradiated with light. The light emitted from the photoirradiation units 30 contains ultraviolet rays in a waveband effective for curing the ink. Thus, the irradiation of the ink on the print medium 9 with light increases the viscosity of the ink.

It is, however, noted that the amount of light emitted from the photoirradiation units 30 is smaller than the amount of light emitted from the fixing unit 50, which will be described later. Thus, the ink on the print medium 9 is not completely cured. That is, each color ink on the print medium 9 is semi-cured to have lower flowability by the light emitted from the photoirradiation units 30. When the ink is semi-cured, the spreading of the ink on the print medium 9 is suppressed. Therefore, degradation in print quality resulting from the spreading of the ink is less likely to occur in the transport path on the downstream side of the photoirradiation units 30.

Note that a detailed structure of the photoirradiation units 30 will be described later.

The base unit 40 is a frame for supporting the five ejection heads 20 and the two photoirradiation units 30. The base unit 40 is fixedly attached to the housing 70 of the printing system 1. The base unit 40 includes five first bases 41 and two second bases 42. The five first bases 41 and the two second bases 42 are aligned in the transport direction of the print medium 9.

The five ejection heads 20 are mounted respectively on the first bases 41. This allows the support of the five ejection heads 20 and secures the position of each ejection head 20. Each first base 41 has a rectangular opening 411 in the center. Each ejection head 20 is fixedly attached to the first base 41 while its lower end is fitted in the opening 411. Therefore, the lower surface of each ejection head 20 mounted on the first base 41 faces the printing surface of the print medium 9 without being shielded by the first base 41.

The two photoirradiation units 30 are mounted respectively on the second bases 42. This allows the support of the two photoirradiation units 30 and secures the position of each photoirradiation unit 30. Note that a detailed structure of the second bases 42 will be described later.

The fixing unit 50 is a unit that fully cures the ink by irradiating the semi-cured ink on the print medium 9 with light. The fixing unit 50 is arranged downstream of the five ejection heads 20 and the two photoirradiation units 30 in the transport path. The fixing unit 50 includes a metal halide lamp 51 and a reflector 52. The light emitted from the metal halide lamp 51 irradiates the ink on the print medium 9 either directly or after being reflected by the reflector 52.

The light emitted from the metal halide lamp 51 contains ultraviolet rays in a waveband effective for curing the ink. The light emitted from the metal halide lamp 51 is enough in amount to completely cure the ink. Thus, when light is emitted from the metal halide lamp 51 onto the ink on the print medium 9, the ink is cured enough and fixed on the print medium 9.

Thereafter, the print medium 9 that has passed through the fixing unit 50 is collected by the rewinder 13 via the transport rollers 12.

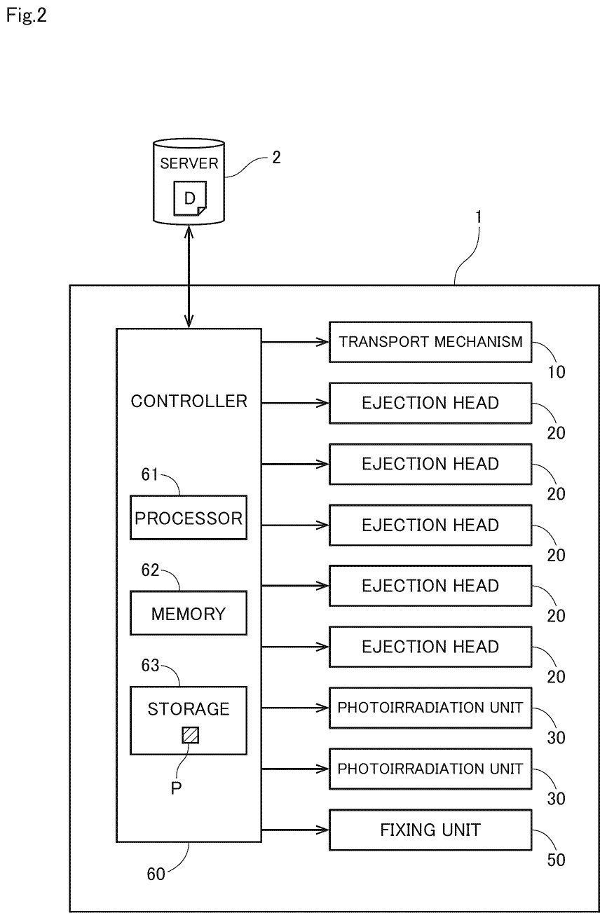

The controller 60 is a unit that controls operations of each constituent element of the printing system 1. FIG. 2 is a control block diagram of the printing system 1. The controller 60 is configured as a computer that includes a processor 61 such as a CPU, memory 62 such as RAM, and a storage 63 such as a hard disk drive. The storage 63 stores a computer program P for controlling the operations of the printing system 1.

The controller 60 is electrically connected to each of the transport mechanism 10, the five ejection heads 20, the two photoirradiation units 30, and the fixing unit 50 described above. The controller 60 controls the operations of the aforementioned constituent element by causing the processor 61 to temporarily read out the computer program P stored in the storage 63 into the memory 62 and performing arithmetic processing in accordance with the computer program P. In this way, print processing proceeds in the printing system 1.

The controller 60 is also electrically connected to the server 2 installed outside the printing system 1. The server 2 stores image data D to be printed. In the print processing, the transport mechanism 10 transports the print medium 9, and the controller 60 reads out designated image data D from the server 2 and causes each ejection head 20 to eject each color ink in accordance with the image data D. As a result, an image corresponding to the image data D is recorded on the printing surface of the print medium 9.

### 2. Configurations of Photoirradiation Units and Second Bases

The following description is given of the detailed structures of the photoirradiation units 30 and the second bases 42 described above.

### 2-1. First Embodiment

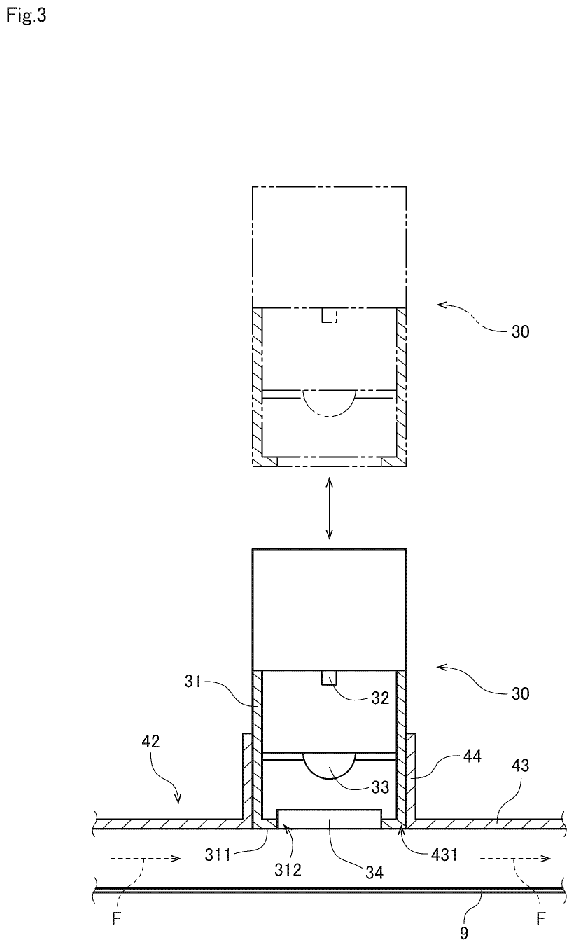

FIG. 3 illustrates configurations of one photoirradiation unit 30 and one second base 42 according to a first embodiment. In the illustration of FIG. 3, the photoirradiation unit 30 when mounted on the second base 42 is shown in solid lines, and the photoirradiation unit 30 when detached from the second base 42 is shown in virtual lines (chain double-dashed lines). As shown in FIG. 3, the photoirradiation unit 30 includes a case 31, a light source 32, a light converging lens 33, and a light transmissible member 34.

The case 31 is a casing in which the light source 32 and the light converging lens 33 are placed. The case 31 has a flat lower surface 311. The lower surface 311 of the case 31 is arranged in approximately parallel with the upper surface of the print medium 9 transported by the transport mechanism 10. The lower surface 311 of the case 31 has an opening 312. The opening 312 is a through hole that penetrates the lower surface 311 of the case 31 in the up-down direction.

The light source 32 is arranged in the case 31. The light source 32 is fixedly attached to the case 31. The light source 32 may be, for example, a plurality of light-emitting diodes (LEDs). The LEDs are aligned in the width direction of the print medium 9. When current is supplied from the controller 60 to the light source 32, the light source 32 emits light. Then, the light is emitted downward from the light source 32. The light emitted from the light source 32 contains ultraviolet rays for curing the ink.

The light converging lens 33 is a lens for causing the light emitted from the light source 32 to converge. The light converging lens 33 is arranged downward of the light source 32 inside the case 31. The light converging lens 33 is fixedly attached to the case 31. The light converging lens 33 may be a stick-like rod lens. The light converging lens 33 is arranged horizontally in the width direction of the print medium 9. That is, the light converging lens 33 is arranged in a posture parallel to the lower surface 311 of the case 31. As shown in FIG. 3, the lower surface of the light converging lens 33 is a convex surface that protrudes downward.

The light transmissible member 34 is a transparent plate arranged in the opening 312 of the case 31. The light transmissible member 34 is fixedly attached to the case 31. The light transmissible member 34 has a flat upper surface and a flat lower surface. The light that has been emitted from the light source 32 and converged by the light converging lens 33 permeates the light transmissible member 34 and irradiates the upper surface of the print medium 9.

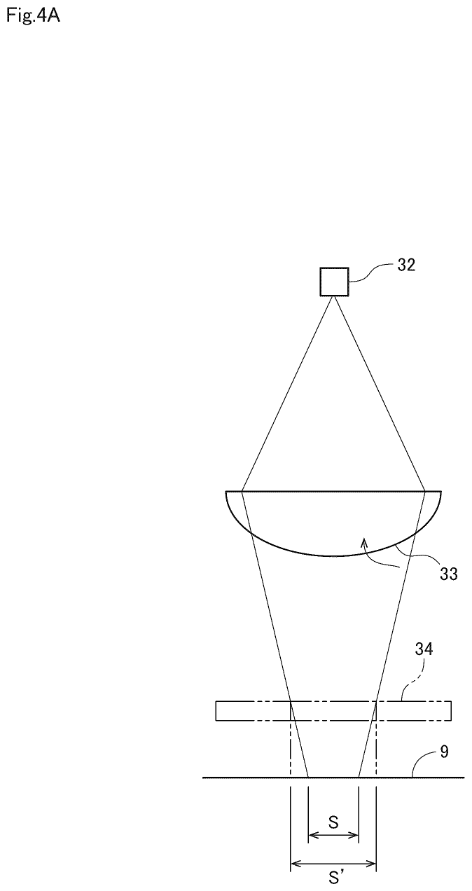

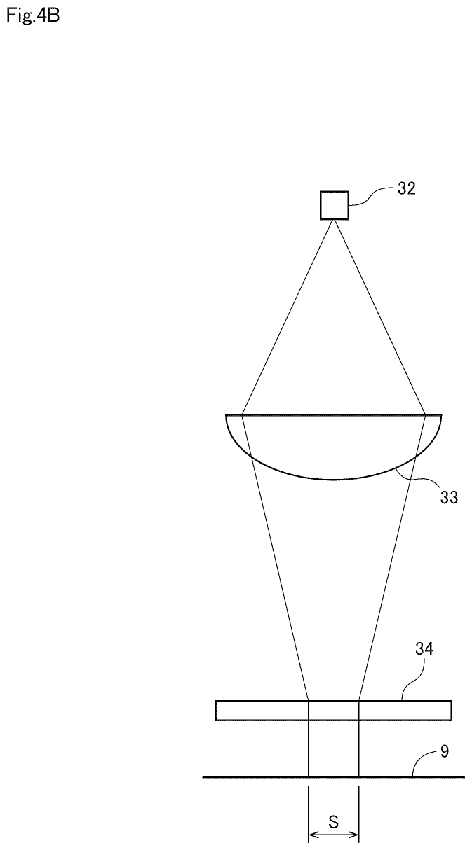

FIG. 4 illustrates the arrangement of the light source 32 and the light converging lens 33 in the case (a) where there is no light transmissible member 34 (Comparative Example) and in the case (b) where there is the light transmissible member 34 (Example). In order to properly cure the ink, it is necessary to appropriately control the amount of light applied per unit area of the upper surface of the print medium 9. For that, it is necessary to set an area S of a spot to a specific size, the spot being formed on the upper surface of the print medium 9 by the light that has been emitted from the light source 32 and converged by the light converging lens 33.

In the case where there is no light transmissible member 34 as shown in (a) in FIG. 4, if the light transmissible member 34 is additionally provided without changing the height positions of the light source 32 and the light converging lens 33, an area S′ of the sport formed on the upper surface of the print medium 9 becomes larger than the normal area S as shown in virtual lines (chain double-dashed lines) in (a) in FIG. 4. Thus, in the case of arranging the light transmissible member 34, as shown in (b) in FIG. 4, the height positions of the light source 32 and the light converging lens 33 are made higher than the height positions shown in (a) in FIG. 4. This allows the spot formed on the upper surface of the print medium 9 to have the appropriate area S. Accordingly, it is possible to favorably cure the ink on the print medium 9.

The description returns to FIG. 3. The second base 42 includes a base plate 43 and a wall 44. The base plate 43 expands in parallel with the upper surface of the print medium 9. The base plate 43 has a rectangular opening 431 in the center. The opening 431 is a through hole that penetrates the base plate 43 in the up-down direction. The wall 44 extends upward from the edge of the opening 431 of the base plate 43. The photoirradiation unit 30 is inserted into the inside of the wall 44. Then, the case 31 is fixedly attached to the second base 42 while the lower end of the case 31 is fitted in the opening 431. Accordingly, the lower surface of the photoirradiation unit 30 and the upper surface of the print medium 9 face each other in the up-down direction with clearance in between.

When the printing system 1 performs the print processing, the print medium 9 is transported to the downstream side in the transport direction. At this time, along with the movement of the print medium 9, an airflow F (viscous flow) that is flowing downstream in the transport direction is produced in the space between the photoirradiation unit 30 and the print medium 9. When ink droplets are ejected from the ejection outlets of the ejection heads 20, a mist smaller than the ink droplets is produced. The aforementioned airflow F contains such a fine mist of ink. Thus, if the aforementioned airflow F becomes disturbed, the mist of the ink contained in the airflow F will adhere to, for example, the lower surfaces of the ejection heads 20, the lower surfaces of the photoirradiation units 30, and the lower surface of the base unit 40. If the adhering mist is accumulated and becomes a relatively large droplet, the droplet may drop onto the upper surface of the print medium 9.

In this regard, each photoirradiation unit 30 according to the present embodiment includes the light transmissible member 34 arranged in the lower surface 311 of the case 31. Then, the light transmissible member 34 has a flat lower surface that is parallel to the upper surface of the print medium 9. This prevents the light converging lens 33 from being exposed to the lower surface of the photoirradiation unit 30 and accordingly prevents the occurrence of disturbances in the airflow F between the photoirradiation unit 30 and the print medium 9, which may be caused by the convex shape of the light converging lens 33. Accordingly, it is possible to reduce the possibility that the mist of the ink may adhere to, for example, the lower surfaces of the ejection heads 20, the lower surfaces of the photoirradiation units 30, and the lower surface of the base unit 40 due to the occurrence of disturbances in the airflow F.

In particular, according to the present embodiment, the lower surface of the light transmissible member 34 and the lower surface 311 of the case 31 are arranged in the same plane. This prevents a step height from being generated at the boundary between the lower surface of the light transmissible member 34 and the lower surface 311 of the case 31. Accordingly, it is possible to reduce the occurrence of disturbances in the airflow F due to the presence of a step height between the photoirradiation unit 30 and the print medium 9. Note that the lower surface of the light transmissible member 34 and the lower surface 311 of the case 31 may be arranged in approximately the same plane. That is, an extremely slight step height (e.g., a step height having a thickness of less than or equal to the thickness of the light transmissible member 34) may be present at the boundary between the lower surface of the light transmissible member 34 and the lower surface 311 of the case 31.

In the present embodiment, the lower surface of the light transmissible member 34, the lower surface 311 of the case 31, and the lower surface of the second base 42 are arranged in the same plane. This prevents a step height from being generated not only at the boundary between the lower surface of the light transmissible member 34 and the lower surface 311 of the case 31, but also at the boundary between the lower surface 311 of the case 31 and the lower surface of the second base 42. Accordingly, it is possible to further reduce the occurrence of disturbances in the airflow F due to the presence of a step height between the photoirradiation unit 30 and the print medium 9.

Note that the lower surface of the light transmissible member 34, the lower surface 311 of the case 31, and the lower surface of the second base 42 may be arranged in approximately the same plane. That is, an extremely slight step height (e.g., a step height having a thickness of less than or equal to the thickness of the light transmissible member 34) may be present at the boundary between the lower surface of the light transmissible member 34 and the lower surface 311 of the case 31 and at the boundary between the lower surface of the case 31 and the lower surface of the second base 42.

It is more preferable that the lower surfaces of the ejection heads 20, the lower surfaces of the first bases 41, the lower surfaces of the light transmissible members 34, the lower surface 311 of the case 31, and the lower surfaces of the second bases 42 are arranged in the same plane. This prevents a step height from being generated at the boundaries between the lower surfaces of the ejection heads 20 and the lower surfaces of the first bases 41 and at the boundaries between the lower surfaces of the first bases 41 and the lower surfaces of the second bases 42. Accordingly, it is possible to further reduce the occurrence of disturbances in the airflow F due to the presence of a step height between the print medium 9 and the ejection heads 20 and between the print medium 9 and the photoirradiation units 30.

Moreover, at least the first base 41 on which the ejection head 20 for ejecting black (K) color ink is mounted and the second base 42 that is located immediately downstream of this first base 41 and on which the photoirradiation unit 30 is mounted may be configured as an integral member, or may be configured by different members. Furthermore, the first base 41 on which the ejection head 20 for ejecting white (W) color ink is mounted and the second base 42 that is located immediately downstream of this first base 41 and on which the photoirradiation unit 30 is mounted may be configured as an integral member, or may be configured by different members. Furthermore, the first bases 41 on which the ejection heads 20 for ejecting all the color ink are mounted and the second bases 42 on which all of the photoirradiation units 30a are mounted may be configured as an integral member, or all may be configured by different members.

Note that the lower surfaces of the ejection heads 20, the lower surfaces of the first bases 41, the lower surfaces of the light transmissible members 34, the lower surfaces 311 of the cases 31, and the lower surfaces of the second bases 42 may be arranged in approximately the same plane. That is, an extremely slight step height (e.g., a step height having a thickness of less than or equal to the thickness of the light transmissible member 34) may be present at the boundaries of these constituent elements.

### 2-2. Second Embodiment

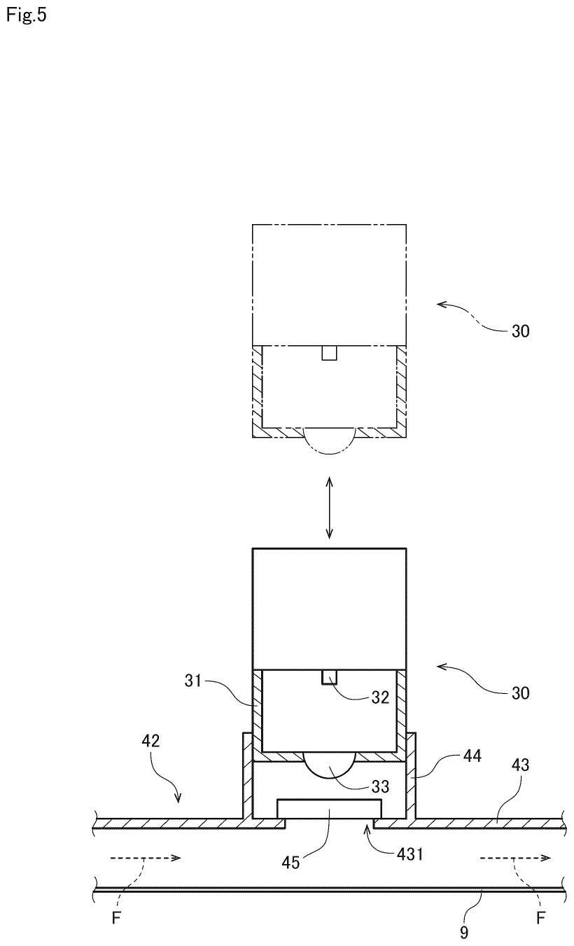

Next, a second embodiment will be described. FIG. 5 illustrates configurations of one photoirradiation unit 30 and one second base 42 according to the second embodiment. In the illustration of FIG. 5, the photoirradiation unit 30 when attached to the second base 42 is shown in solid lines, and the photoirradiation unit 30 when detached from the second base 42 is shown in virtual lines (chain double-dashed lines).

As shown in FIG. 5, the photoirradiation unit 30 according to the present embodiment includes a case 31, a light source 32, and a light converging lens 33. The photoirradiation unit 30 emits the light emitted from the light source 32 downward via the light converging lens 33. Although the photoirradiation unit 30 according to the above-described first embodiment includes the light transmissible member 34, the photoirradiation unit 30 according to the second embodiment does not include the light transmissible member 34. Thus, the convex lower surface of the light converging lens 33 is exposed to the lower surface of the photoirradiation unit 30.

The second base 42 according to the present embodiment includes a base plate 43, a wall 44, and a light transmissible member 45. The base plate 43 expands in parallel with the upper surface of the print medium 9. The base plate 43 has a rectangular opening 431 in the center. The opening 431 is a through hole that penetrates the base plate 43 in the up-down direction. The wall 44 extends upward from the base plate 43. The light transmissible member 45 is a transparent plate arranged in the opening 431 of the base plate 43. The light transmissible member 45 is fixedly attached to the base plate 43. The light transmissible member 45 has a flat upper surface and a flat lower surface.

The photoirradiation unit 30 is fixedly attached to the wall 44 while the lower end of the case 31 is inserted into the inside of the wall 44. Accordingly, the light converging lens 33 is arranged above the light transmissible member 45 with clearance in between. The light that has been emitted from the light source 32 and converged by the light converging lens 33 permeates the light transmissible member 34 and irradiates the upper surface of the print medium 9.

In the configuration according to the present embodiment, the light transmissible member 45 is arranged so as to face the upper surface of the print medium 9. The light transmissible member 45 has a flat lower surface parallel to the upper surface of the print medium 9. The light converging lens 33 is not exposed to the space in which the airflow F is produced. Thus, it is possible to reduce the occurrence of disturbances in the airflow F due to the convex shape of the light converging lens 33 between the photoirradiation unit 30 and the print medium 9.

In the example shown in FIG. 5, a slight step height is present at the boundary between the lower surface of the light transmissible member 45 and the lower surface of the second base 42, but this step height is smaller than the thickness of the light transmissible member 45. In this way, it is preferable that the lower surface of the light transmissible member 45 and the lower surface of the second base 42 may be arranged in approximately the same plane. This reduces the occurrence of disturbances in the airflow F due to the presence of such a step height. Note that the lower surface of the light transmissible member 45 and the lower surface of the second base 42 may be arranged in the same plane by fitting the light transmissible member 45 into the opening 431 of the second base 42. This further reduces the occurrence of disturbances in the airflow F due to the presence of a step height.

It is more preferable that the lower surfaces of the ejection heads 20, the lower surfaces of the first bases 41, the lower surfaces of the light transmissible members 45, and the lower surfaces of the second bases 42 may be arranged in the same plane or in approximately the same plane. This prevents the formation of a step height at the boundaries of the constituent elements. Accordingly, it is possible to further reduce the occurrence of disturbances in the airflow F due to the presence of a step height.

### 2-3. Third Embodiment

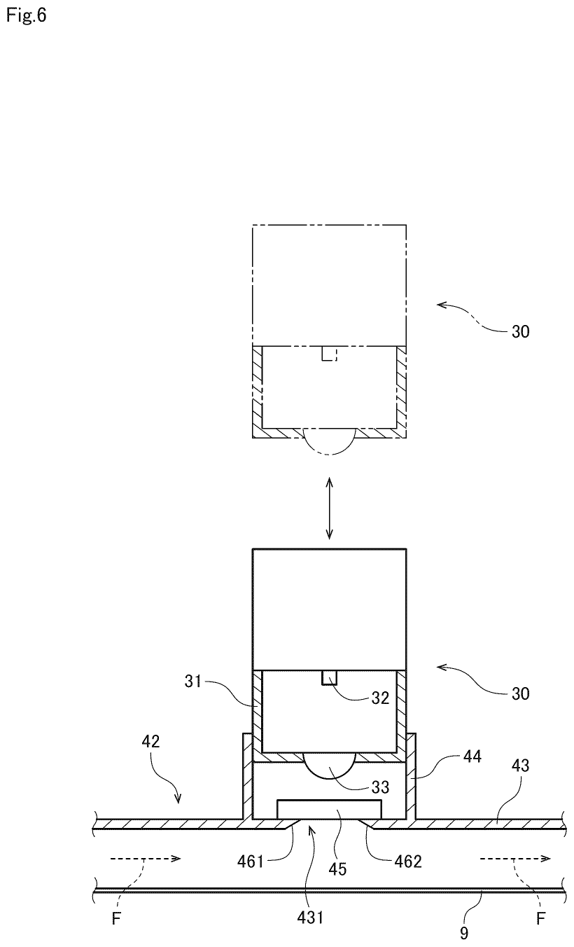

Next, a third embodiment will be described. FIG. 6 illustrates configurations of one photoirradiation unit 30 and one second base 42 according to the third embodiment. In the illustration of FIG. 6, the photoirradiation unit 30 when attached to the second base 42 is shown in solid lines, and the photoirradiation unit 30 when detached from the second base 42 is shown in virtual lines (chain double-dashed lines).

The photoirradiation unit 30 shown in FIG. 6 is equivalent to the photoirradiation unit 30 shown in FIG. 5. The second base 42 shown in FIG. 6 differs from the second base 42 shown in FIG. 5 only in that the second base 42 shown in FIG. 6 includes a first rectifier surface 461 and a second rectifier surface 462.

The first rectifier surface 461 is provided on the upstream side of the opening 431 of the base plate 43. The first rectifier surface 461 extends from the lower surface of the second base 42 in a direction toward the lower surface of the light transmissible member 45 exposed to the opening 431. The first rectifier surface 461 is inclined so as to have gradually increased height in a direction toward the downstream side in the transport direction of the print medium 9.

The second rectifier surface 462 is provided on the downstream side of the opening 431 of the base plate 43. The second rectifier surface 462 extends from the lower surface of the second base 42 in a direction toward the lower surface of the light transmissible member 45 exposed to the opening 431. The second rectifier surface 462 is inclined so as to have gradually increased height in a direction toward the upstream side in the transport direction of the print medium 9.

The presence of the first rectifier surface 461 and the second rectifier surface 462 makes gentle the step height at the boundary between the lower surface of the light transmissible member 45 and the lower surface of the second base 42. This further reduces the occurrence of disturbances in the airflow F at the boundary between the lower surface of the light transmissible member 45 and the lower surface of the second base 42. Accordingly, it is possible to further reduce the possibility that the mist of the ink may adhere to, for example, the lower surfaces of the ejection heads 20, the lower surfaces of the photoirradiation units 30, and the lower surface of the base unit 40 due to the occurrence of disturbances in the airflow F.

### 2-4. Fourth Embodiment

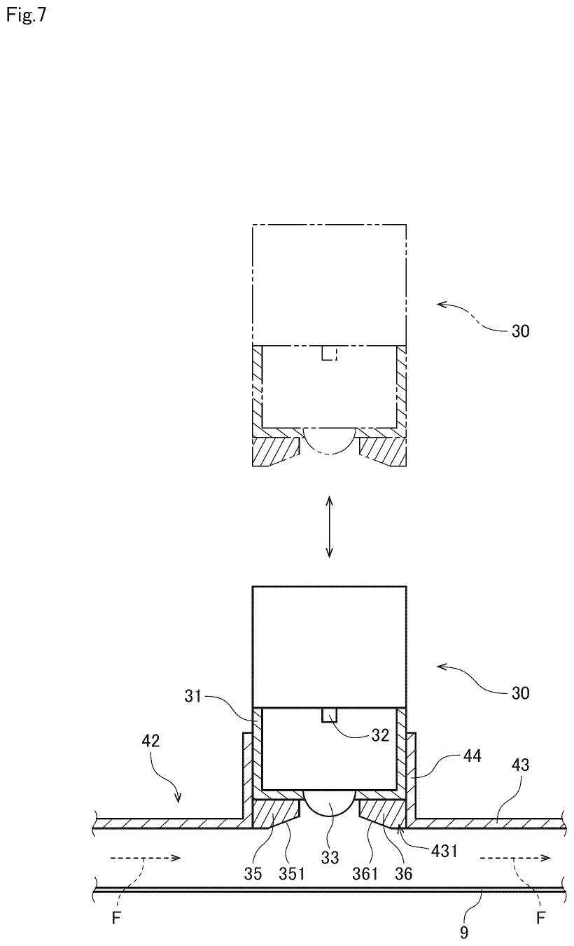

Next, a fourth embodiment will be described. FIG. 7 illustrates configurations of one photoirradiation unit 30 and one second base 42 according to the fourth embodiment. In the illustration of FIG. 7, the photoirradiation unit 30 when attached to the second base 42 is shown in solid lines, and the photoirradiation unit 30 when detached from the second base 42 is shown in virtual lines (chain double-dashed lines).

As shown in FIG. 7, the photoirradiation unit 30 according to the present embodiment includes a case 31, a light source 32, and a light converging lens 33. The photoirradiation unit 30 according to the present embodiment does not include the light transmissible member 34. Thus, the convex lower surface of the light converging lens 33 is exposed to the lower surface of the photoirradiation unit 30. The photoirradiation unit 30 irradiates the upper surface of the print medium 9 with the light emitted from the light source 32 via the light converging lens 33.

In the fourth embodiment, the photoirradiation unit 30 includes a first rectifier member 35 and a second rectifier member 36. The first rectifier member 35 and the second rectifier member 36 are fixedly attached to the lower surface of the case 31.

The first rectifier member 35 has a first rectifier surface 351. The first rectifier surface 351 is located upstream of the light converging lens 33 in the transport direction of the print medium 9. The first rectifier surface 351 extends from the lower surface of the first rectifier member 35 in a direction toward the vicinity of the lower end portion of the light converging lens 33. The first rectifier surface 351 is inclined so as to have gradually increased height in a direction toward the vicinity of the lower end portion of the light converging lens 33.

The second rectifier member 36 has a second rectifier surface 361. The second rectifier surface 361 is located downstream of the light converging lens 33 in the transport direction of the print medium 9. The second rectifier surface 361 extends from the lower surface of the second rectifier member 36 in a direction toward the vicinity of the lower end portion of the light converging lens 33. The second rectifier surface 361 is inclined so as to have gradually increased height in a direction toward the vicinity of the lower end portion of the light converging lens 33.

The second base 42 according to the present embodiment includes a base plate 43 and a wall 44. The base plate 43 expands in parallel with the upper surface of the print medium 9. The base plate 43 has a rectangular opening 431 in the center. The opening 431 is a through hole that penetrates the base plate 43 in the up-down direction. The wall 44 extends upward from the edge of the opening 431 of the base plate 43. The photoirradiation unit 30 is inserted into the inside of the wall 44. Then, the case 31 is fixedly attached to the second base 42 while the lower end portion of the case 31 is fitted in the opening 431.

The presence of the first rectifier surface 351 and the second rectifier surface 361 in the lower surface of the photoirradiation unit 30 as in the present embodiment diminishes the step height at the boundary between the lower surface of the light converging lens 33 and the lower surface of the second base 42. The airflow F flowing above the print medium 9 is guided along the lower surfaces of the ejection heads 20, the lower surfaces of the first bases 41, the lower surfaces of the second bases 42, the first rectifier surfaces 351, and the second rectifier surfaces 361. This reduces the occurrence of disturbances in the airflow F. Accordingly, it is possible to reduce the possibility that the mist of the ink may adhere to, for example, the lower surfaces of the ejection heads 20, the lower surfaces of the photoirradiation units 30, and the lower surface of the base unit 40 due to the occurrence of disturbances in the airflow F.

In the example shown in FIG. 7, the first rectifier surface 351 and the second rectifier surface 361 are inclined so as to have gradually increased height in the direction toward the vicinity of the lower end portion of the light converging lens 33. However, in the case where the lower end portion of the light converging lens 33 is located below the lower surface of the base plate 43, the first rectifier surface 351 and the second rectifier surface 361 may be inclined so as to have gradually decreased height in the direction toward the vicinity of the lower end portion of the light converging lens 33.

### 2-5. Fifth Embodiment

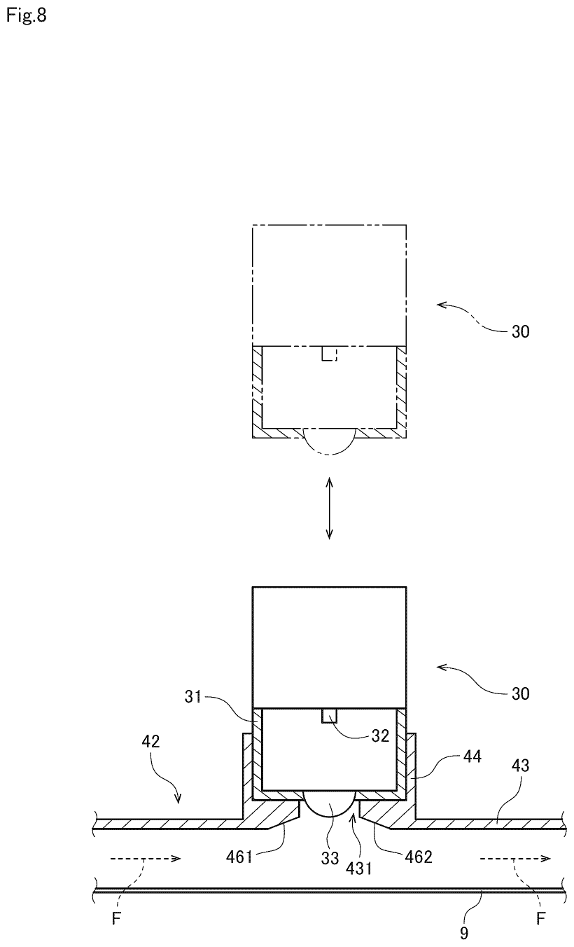

Next, a fifth embodiment will be described. FIG. 8 illustrates configurations of one photoirradiation unit 30 and one second base 42 according to the fifth embodiment. In the illustration of FIG. 8, the photoirradiation unit 30 when attached to the second base 42 is shown in solid lines, and the photoirradiation unit 30 when detached from the second base 42 is shown in virtual lines (chain double-dashed lines).

As show in FIG. 8, the photoirradiation unit 30 according to the present embodiment includes a case 31, a light source 32, and a light converging lens 33. The photoirradiation unit 30 according to the present embodiment does not include the light transmissible member 34. Thus, the convex lower surface of the light converging lens 33 is exposed to the lower surface of the photoirradiation unit 30. The photoirradiation unit 30 irradiates the upper surface of the print medium 9 with the light emitted from the light source 32 via the light converging lens 33.

The second base 42 according to the present embodiment includes a base plate 43 and a wall 44. The base plate 43 has a rectangular opening 431 in the center. The opening 431 is a through hole that penetrates the base plate 43 in the up-down direction. The wall 44 extends upward from the base plate 43.

The photoirradiation unit 30 is fixedly attached to the second base 42 while the lower end portion of the case 31 is inserted into the inside of the wall 44 and placed on the upper surface of the base plate 43. The light converging lens 33 is arranged in the opening 431 of the base plate 43. Accordingly, the light converging lens 33 and the upper surface of the print medium 9 face each other in the up-down direction with clearance in between.

In the fourth embodiment, the lower surface of the base plate 43 includes a first rectifier surface 461 and a second rectifier surface 462.

The first rectifier surface 461 is provided upstream of the opening 431 of the base plate 43. That is, when the photoirradiation unit 30 is supported by the second base 42, the first rectifier surface 461 is located upstream of the light converging lens 33. The first rectifier surface 461 extends from the lower surface of the second base 42 in a direction toward the vicinity of the lower end portion of the light converging lens 33 exposed to the opening 431. The first rectifier surface 461 is inclined so as to have gradually increased height in the direction toward the vicinity of the lower end portion of the light converging lens 33.

The second rectifier surface 462 is provided downstream of the opening 431 of the base plate 43. That is, when the photoirradiation unit 30 is supported by the second base 42, the second rectifier surface 462 is located downstream of the light converging lens 33. The second rectifier surface 462 extends from the lower surface of the second base 42 in a direction toward the vicinity of the lower end portion of the light converging lens 33 exposed to the opening 431. The second rectifier surface 462 is inclined so as to have gradually increased height in the direction toward the vicinity of the lower end portion of the light converging lens 33.

The presence of the first rectifier surface 461 and the second rectifier surface 462 diminishes the step height at the boundary between the lower surface of the light converging lens 33 and the lower surface of the second base 42. The airflow F flowing above the print medium 9 is guided along the lower surfaces of the ejection heads 20, the lower surfaces of the first bases 41, the lower surfaces of the second bases 42, the first rectifier surfaces 461, and the second rectifier surfaces 462. This reduces the occurrence of disturbances in the airflow F. Accordingly, it is possible to reduce the possibility that the mist of the ink may adhere to, for example, the lower surfaces of the ejection heads 20, the lower surfaces of the photoirradiation units 30, and the lower surfaces of the base units 40 due to the occurrence of disturbances in the airflow F.

In the example shown in FIG. 8, the first rectifier surface 461 and the second rectifier surface 462 are inclined so as to have gradually increased height in the direction toward the vicinity of the lower end portion of the light converging lens 33. However, in the case where the lower end portion of the light converging lens 33 is located below the lower surface of the base plate 43, the first rectifier surface 461 and the second rectifier surface 462 may be inclined so as to have gradually decreased height in the direction toward the vicinity of the lower end portion of the light converging lens 33.

### 3. Variations

While some embodiments of the present invention have been described thus far, the present invention is not intended to be limited to the above-described embodiments.

The photoirradiation units 30 according to the above-described embodiments are configured to semi-cure the ink supplied to the print medium 9. Alternatively, the photoirradiation units 30 according to the present invention may be configured to fully cure the ink supplied to the print medium 9.

The printing system 1 according to the above-described embodiments includes the five ejection heads 20. However, the number of ejection heads included in the printing system may be in the range of one to four, or may be six or more. For example, the printing system may include an ejection head that ejects specific color ink, in addition to the ejection heads that eject W, C, M, Y, and K color ink. The printing system may further include an ejection head that ejects primer ink for improving wettability of a print medium. As another alternative, each ejection head may be configured by a plurality of heads aligned in the width direction of a print medium.

The printing system 1 according to the above-described embodiments includes the two photoirradiation units 30. However, the number of photoirradiation units 30 included in the printing system may be one, or may be three or more. For example, one photoirradiation unit 30 may be arranged only on the downstream side of the ejection head 20 that is located on the most downstream side. Alternatively, the photoirradiation units 30 may be arranged on the downstream side of every ejection head 20.

The printing system 1 according to the above-described embodiments is configured to perform printing on the long band-like continuous print medium 9. However, the printing system according to the present invention may be configured to perform printing on a plurality of print media while transporting the print media in sequence.

Detailed shapes of the photoirradiation units, the printer, and the printing system may be different from those shown in the drawings of the present application. Each element used in the above-described embodiments and variations may be appropriately combined within a range that presents no contradictions.

### REFERENCE SIGNS LIST

1 printing system
9 print medium
10 transport mechanism
20 ejection head
30 photoirradiation unit
31 case
32 light source
33 light converging lens
34 light transmissible member
35 first rectifier member
36 second rectifier member
40 base unit
41 first base
42 second base
43 base plate
44 wall
45 light transmissible member
50 fixing unit
60 controller
311 lower surface of case
312 opening of case
351 first rectifier surface
361 second rectifier surface
411 opening of first base
431 opening of second base
461 first rectifier surface
462 second rectifier surface
F airflow
S area of spot

1. A photoirradiation unit for irradiating photo-curing ink supplied to a print medium with light, the photoirradiation unit comprising:
a case having a lower surface having an opening;
a light source arranged in the case;
a light converging lens that is arranged in the case and that causes light emitted from the light source to converge; and
a light transmissible member that is arranged in the opening of the case and that permeates light that has converged by the light converging lens,
wherein the light transmissible member has a flat lower surface.

2. The photoirradiation unit according to claim 1, wherein
light that has been emitted from the light source and permeated the light converging lens and the light transmissible member forms a spot of a predetermined area on a surface of the print medium, and
the light source and the light converging lens are located in height positions that are higher than height positions in which the light source and the light converging lens are located when the spot of the predetermined area is formed on the print medium in the absence of said light transmissible member.

3. The photoirradiation unit according to claim 1, wherein
the lower surface of the light transmissible member and the lower surface of the case are located in the same plane or in approximately the same plane.

4. The photoirradiation unit according to claim 1, wherein
the light converging lens is a rod lens that extends in parallel with the lower surface of the case.

5. A printing system comprising:
a transport mechanism that transports a print medium along a predetermined transport path;
an ejection head that ejects photo-curing ink from a plurality of ink ejection outlets to the print medium that is transported by the transport mechanism;
a first base that supports the ejection head;
the photoirradiation unit according to claim 1; and
a second base that supports the photoirradiation unit,
wherein the photoirradiation unit irradiates the print medium with light on a downstream side of the ejection head in the transport path, and
the lower surface of the light transmissible member and a lower surface of the second base are located in the same plane or in approximately the same plane.

6. The printing system according to claim 5, wherein
a lower surface of the ejection head, a lower surface of the first base, the lower surface of the light transmissible member, and the lower surface of the second base are located in the same plane or in approximately the same plane.

7. A printer comprising:
a transport mechanism that transports a print medium along a predetermined transport path;
an ejection head that ejects photo-curing ink from a plurality of ink ejection outlets to the print medium that is transported by the transport mechanism;
a first base that supports the ejection head; and
a second base capable of supporting a photoirradiation unit that irradiates the ink supplied to the print medium with light via a light converging lens,
wherein the second base includes:
a base plate having an opening; and
a light transmissible member arranged in the opening, and
the light transmissible member has a flat lower surface.

8. The printer according to claim 7, wherein
when the photoirradiation unit is supported by the second base, a lower surface of the ejection head, a lower surface of the first base, the lower surface of the light transmissible member, and a lower surface of the second base are located in the same plane or in approximately the same plane.

9. The printer according to claim 7, wherein
the second base has rectifier surfaces that are located on upstream and downstream sides of the opening in the transport direction of the print medium and that extends in a direction toward the lower surface of the light transmissible member.

10. A photoirradiation unit for irradiating photo-curing ink supplied to a print medium with light, the photoirradiation unit comprising:
a light source that emits light;
a light converging lens that causes the light emitted from the light source to converge; and
rectifier surfaces that are located on upstream and downstream sides of the light converging lens in a transport direction of the print medium and that extends in a direction toward a vicinity of a lower end portion of the light converging lens.

11. The photoirradiation unit according to claim 10, wherein
the rectifier surfaces include:
a first rectifier surface that is located upstream of the light converging lens in the transport direction of the print medium and that is inclined to have gradually increased height in the direction toward the vicinity of the lower end portion of the light converging lens; and
a second rectifier surface that is located downstream of the light converging lens in the transport direction of the print medium and that is inclined to have gradually increased height in the direction toward the vicinity of the lower end portion of the light converging lens.

12. A printing system comprising:
a transport mechanism that transports a print medium in a predetermined transport path;
an ejection head that ejects photo-curing ink from a plurality of ink ejection outlets to the print medium that is transported by the transport mechanism;
a first base that supports the ejection head;
the photoirradiation unit according to claim 10; and
a second base that supports the photoirradiation unit,
wherein the photoirradiation unit irradiates the print medium with light at a position located downstream of the ejection head in the transport path, and
the rectifier surfaces and a lower surface of the second base guide an airflow that is flowing above the print medium.

13. The printing system according to claim 12, wherein
the rectifier surfaces, a lower surface of the ejection head, a lower surface of the first base, and the lower surface of the second base guide the airflow that is flowing above the print medium.

14. A printer comprising:
a transport mechanism that transports a print medium along a predetermined transport path;
an ejection head that ejects photo-curing ink from a plurality of ink ejection outlets to the print medium that is transported by the transport mechanism;
a first base that supports the ejection head; and
a second base capable of supporting a photoirradiation unit that irradiates the ink supplied to the print medium with light via a light converging lens,
wherein the second base has rectifier surfaces that are located on upstream and downstream sides of the light converging lens in a transport direction of the print medium and extends in a direction toward a vicinity of a lower end portion of the light converging lens, while the second base supports the photoirradiation unit.
